(19) United States
(12) Patent Application Publication
(10) Pub. No.: US 2015/0153245 A1
(43) Pub. Date: Jun. 4, 2015

(54) INTEGRITY TESTING APPARATUS AND RELATED METHODS

(71) Applicant: PALL TECHNOLOGY UK LIMITED, PORTSMOUTH (GB)

(72) Inventors: Alexandre Terentiev, Lexington, KY (US); Sergey Terentiev, Chaska, MN (US); Vishwas Pethe, Shakopee, MN (US); Anthony Paganelli, Trenton, OH (US); Richard Bhella, Gilbert, AZ (US)

(21) Appl. No.: 14/403,799

(22) PCT Filed: Oct. 24, 2013
(86) PCT No.: PCT/US2013/066614

§ 371 Date: Nov. 25, 2014

Related U.S. Application Data
(60) Provisional application No. 61/717,959, filed on Oct. 24, 2012.
(60) Provisional application No. 61/873,138, filed on Sep. 3, 2013.
(60) Provisional application No. 61/790,621, filed on Mar. 15, 2013.

(51) Int. Cl. G01M 3/04

(52) U.S. Cl. CPC G01M 3/04

(57) ABSTRACT

Apparatus and methods are provided for the integrity testing of objects. One apparatus comprises a container forming a test chamber for receiving the vessel and a spacer for separating the vessel from a surface of the test chamber while constraining the ability of the vessel to inflate. Another apparatus comprises a connector including a film for connecting to a port. The use of a base level of a detectable gas in a test chamber is also proposed. Related methods are also described.

### INTEGRITY TESTING APPARATUS AND RELATED METHODS

This application claims the benefit of U.S. Provisional Patent Application Ser. Nos. 61/790,621, 61/717,959, and 61/873,138, the disclosures of which are incorporated herein by reference.

### TECHNICAL FIELD

This disclosure relates generally to integrity testing, and, more specifically, to testing the integrity of objects having interior compartments.

### BACKGROUND

Containers or vessels in the form of hermetically closed, flexible plastic bags, manifolds, tubing arrangements, and the like, are frequently used in many applications. For example, in the course of bioprocessing, flexible bags are often used for bulk intermediate storage, cell culture re-suspension, viral inactivation, final formulation, final fill, or as bioreactors. In many such applications and others, the bag is pre-sterilized, and such condition must be maintained in order to avoid contamination of the product resulting from use of the bag. In the case of bioprocessing, any breach of the sterile condition is considered to be a serious deviation from the conventional protocol, and often results in the discarding of the batch of valuable product, sometimes after significant cost and effort has been expended in making it.

Most bags, including those of the type commonly used for bioprocessing, comprise one or more relatively thin layers of plastic film and thus are prone to damage during shipping and handling. Moreover, the bags often comprise individual sheets or panels of film welded together (such as by heating or ultrasonic means), which can contribute to defects and concomitant leaks along the corresponding seals thus formed. For these reasons, it is necessary to validate the integrity of the supposedly sterile bag before valuable product is introduced into it. Likewise, it is also often desirable to check the integrity of the used bag after use in order to insure that the integrity of the bag was maintained during the entire period of use (which in the case of bioprocessing can be a relatively long time, such as a few weeks).

A prior commonly assigned application (WO2009/145991, the disclosure of which is incorporated herein by reference) proposed an integrity testing regimen for containers susceptible to leaking using a detectable (i.e., trace) gas, such as helium. Detections of any leak of the detectable gas may indicate a possible breach of the sterile conditions. Another proposal for testing used a conductive system, as disclosed in U.S. Pat. Nos. 7,516,648 and 8,104,328, and incorporated herein by reference. While the testing arrangements proposed are robust and reliable, certain developments have been made to help ensure the reliability, repeatability, and accuracy of the results.

For example, a known manner of integrity testing involves intentionally forming an opening having a known size (e.g., 10μ) in a sample of an existing bag type. Leak testing is then performed on the sample bag by providing it with a detectable gas and, if a leak is detected, then the capacity of the leak detector for detecting leaks is known to a reasonable degree. If no leak is detected, the use of sample bags with different sizes of openings can be repeated until a leak is detected, thereby identifying the minimum sensitivity of the leak detector. As should be appreciated, constructing the opening in the bag to the necessary degree of precision is a time consuming task. Furthermore, in order to test multiple sizes of openings, multiple bags must be constructed, which is costly and time consuming.

A further possible issue with the existing manner of testing is the time that is takes to complete the test. This can be the result of the use of a relatively small amount of detectable gas in a bag having a relatively large volume, and the corresponding amount of time it takes for the gas to spread throughout the volume and “find” the opening to create the leak. Obviously, the time of testing can be a factor not only in the cost of the test, but also the reliability, since a short test time may not allow for the desired reliability to be achieved. However, when a detectable gas is used, it may also be necessary to balance the need for a sufficiently long test with a concern that the longer the testing takes, the more likely diffusion is to occur that is not the result of a leak.

While the use of single-use bags is growing in biopharmaceutical market, a larger increase is observed in the demand for manifolds. A manifold has a central fluid path with branching along the central path created by 4-way connectors and each of the branches further have a bag or a filter connected to it for receiving the fluid. The bags are typically 2D, usually between 50 mL to 20 L bags. In some cases the attached bags may be 3D bags with sizes as larger as 20 L-50 L. Usually, manifolds are quite expensive and it is important to be able to use the entire manifold. More often than not, the product stored in the manifolds is final finish product and is therefore, very expensive material.

At present, there is no reliable method to perform effective integrity check of such manifolds. In particular, existing methods (pressure decay) are not capable of checking very small defects (smaller than 10 micron) and also, cannot verify if flow path to each individual bag is open.

The pressure decay method involves introducing gas in a bag compartment at a gradual rate, stopping the gas introduction after a certain pressure is reached and then, monitoring the loss in pressure for a specified period of time. While this method is useful in single bags for integrity check, it is not very effective in complex manifolds. For instance, if any of the 4-way connector is blocked due to manufacturing error, the pressure decay method cannot detect the blocked condition. The pressure rise/decay profile does not change and therefore, the blockage cannot be detected.

In addition to not being able to check for blockages in manifold, pressure decay cannot test these complex manifolds to the level that is necessary to assure any level of sterility assurance. Standard pressure decay tests can only detect defects in the range of 20 to 90 micron in size and defects smaller than 20 micron may go un-detected. Recent studies have shown that aerosolized bacteria penetrate through defects as small as 12 micron. Regular non-clean room conditions (e.g., people sneezing) are considered similar to aerosolized bacterial challenge. It has also been shown that aerosolized bacteria do not penetrate through defects that are 12 micron or smaller in size, and it is desirable to detect defects that will permit bacteria to pass through. So, a detection of at least 12 micron size defect is important in assuring defect size. In cases where the microbial challenge is a liquid media, the bacteria penetrate through defects as small as 2.65 micron sizes. Consequently, there is a need to detect defects that are at most 2 micron in size.

Finally, the application referenced above proposed a test chamber for performing the testing. As the result of further advances, certain improvements have been contemplated to facilitate efficient and reliable testing of a variety of bags. For one, handling of the bags prior to and during the testing may be done in a manner that helps to avoid any damage, and also the behavior of the bag during the testing can be controlled in a manner that improves the efficiency, reliability, and accuracy of the testing regimen.

### SUMMARY

One aspect of the disclosure pertains to an apparatus for use in integrity testing a bag having a first interior chamber and including at least one port. The apparatus comprises a connector adapted for connecting to the port, the connector comprising a film having an opening formed therein. The opening in the film may form an intentional defect to confirm the accuracy and reliability of the integrity testing.

The connector may comprise a base including at least one perforation for allowing a gas to pass. The film may be connected to a face of the base, or may be provided between an inner surface of the base and the port. The connector may be adapted for connecting to a port comprising a powder port in the bag, and may be tubular. The connector may comprise a metal material, a plastic material, or both. The bag may comprise a film formed of a material corresponding to the material of the film. A plurality of the connectors may be provided, with each having an opening of a different size. The diameter of the opening in the one or more connectors may be in the range of from about 0.01μ to about 100μ.

A further part of the disclosure is a kit comprising a plurality of connectors for connecting to a flexible bag for integrity testing, each connector having an intentional defect of a different diameter. One or more of the connectors may comprise stainless steel. The invention may thus be considered the combination of a connector having an intentional defect and a flexible bag for connecting to the connector (the intentional defect may comprise an opening having a diameter in the range of from about 0.01μ to about 100μ.)

A further aspect of the disclosure relates to a method of performing integrity testing on a bag including a port. The method comprises removably attaching a first film including a first opening to the port. The method may further include the step of placing the bag including the film in a test chamber, pressurizing the test chamber, introducing a detectable gas into the bag, and detecting any detectable gas in the test chamber as a result of passing through the opening in the film. The method may comprise removing the first film, and removably attaching a second film including a second opening to the port, the second opening being different in diameter from the first opening.

Another aspect of the disclosure pertains to a method of performing integrity testing on a container including a port. The method comprises removably attaching a first component including a first opening to the port, providing a detectable gas in the container, and sensing whether the detectable gas is located external to the container. The container may comprise a bag, and the method may include providing the first component comprising a film corresponding to the material of the bag. The container may also comprise a manifold including a plurality of ports, and the method may further include clamping any port not associated with the first component.

The first component may comprise a tube, and the step of connecting the tube to the port of the container may be performed. The method may further include providing a second component having a second opening smaller than the first opening to the port. The steps of removing the first component from the port, removably attaching the second component to the port, delivering the detectable gas to the container, and detecting any detectable gas external to the container may also be performed.

Another aspect of the invention pertains to an apparatus for use in integrity testing an object. The apparatus comprises a container forming a test chamber for receiving the object; and a separator for separating the object from a surface of the test chamber, the separator adapted for being connected to the object. The separator may be pivotally or slidably connected to the object. The separator may be rotatably connected to the chamber. The separator may comprise a grid. When the object comprises a container, the grid includes at least one opening adapted for receiving tubing for connecting to the container. The grid may comprise first openings having a first dimension and second openings having a second dimension. The grid may comprise support members removably mounted in a support frame, which members may comprise opposed, inwardly curved rods adapted for compressing the object.

The separator may include a projecting portion adapted for positioning between two opposing flaps of the object. The separator may include a first projecting portion adapted for positioning between a first pair of opposing flaps of the object and a second projecting portion adapted for positioning between a second pair of opposing flaps. The first projecting portion may be spaced from the second projecting portion a distance corresponding to a space between the ends of the flaps of the object when folded.

One or each projecting portion generally tapers to a point, and may be pivotally mounted to a support frame of the separator. The separator may include at least two pivotally mounted side members, each comprising a grid. The side members may oppose each other and curve inwardly to compress the object during the integrity testing.

The separator may comprise an inverted U-shaped structure having an opening for receiving the object. A removable spacer may also be provided for positioning between two adjacent flaps of the object. The chamber may be elongated in one direction, such as a vertical direction, and may comprise a generally cylindrical body including an outer surface oriented tangentially relative to a horizontal plane.

The container may include a door, which may be made of a transparent material. A shuttle may also be connected to the separator, and the container adapted for receiving the shuttle. The shuttle may include wheels adapted for engaging rails in the container. A dolly may be provided for carrying the shuttle, the separator, or both. An inner surface of the container may include a pattern, such as a plurality of generally hemispherical projections.

A further aspect of the disclosure pertains to an apparatus for integrity testing an object with an interior compartment. The apparatus comprises a test chamber for receiving the object, a first source of a detectable gas adapted for delivering the gas to the object in the chamber, a source of carrier gas connected to the test chamber, and a detector for detecting the detectable gas. The apparatus may further comprise a second source of detectable gas connected to the test chamber.

Still another aspect of this disclosure pertains to an apparatus for integrity testing an object with an interior compartment using a detectable gas delivered to the object. The apparatus comprises a test chamber for receiving the vessel and a first source of a detectable gas arranged for delivering the detectable gas to the test chamber external to the vessel. The apparatus may further comprise a detector for detecting the detectable gas, as well as a source of carrier gas connected to the test chamber. The apparatus may further include a second source for delivering detectable gas to the object.

Yet another aspect of the disclosure relates to an apparatus for use in connection with the integrity testing of an object including at least two opposing flaps or folds in a test chamber. The apparatus comprises a frame for receiving and supporting the object in the test chamber, the frame including at least a first portion adapted for being selectively positioned between the at least two opposing flaps or folds. The first portion may be tapered, and may comprise a generally triangular cross-section. The first portion may also comprise a grid, and may be pivotally mounted to a frame, which may include a second portion adapted for compressing the vessel. The frame may comprise two side supports pivotally mounted to the frame, and the portion comprises at least one first inner support pivotally mounted to the frame.

The vessel may include two pairs of opposing flaps or folds, and the first inner support may be arranged for positioning between a first pair of the flaps. A second inner support may be arranged for positioning between the second pair of flaps. A distance between the first and second inner supports in a home condition may be equal to or greater than a space between the ends of the two pairs of flaps of the vessel. The side supports may be curved inwardly, and at least one of the side supports may comprise modular rods adapted for being arranged to form an opening sized to accommodate an auxiliary structure associated with the vessel.

A further aspect of the disclosure relates to an apparatus for integrity testing an object. The apparatus comprises a container forming a test chamber for receiving the object and a shuttle for supporting the object. The shuttle may be arranged for being removably positioned in the test chamber.

A dolly may also be provided for supporting the shuttle external to the chamber. The dolly may include a first guide, and the chamber includes a second guide adapted for substantially aligning with the first guide for transferring the shuttle from the dolly to the chamber. The dolly may include a first alignment feature for registering with a second alignment feature to ensure alignment between the dolly and the test chamber, which first alignment feature may be located on the container.

The dolly may include at least one structure adapted for engaging an inner side surface of the container. The structure may comprise a wheel. A spacer may also be provided for spacing the object from a wall of the test chamber. The shuttle may comprise an opening for tubing connected to the object.

Still another aspect of the disclosure pertains to an apparatus for positioning in a test chamber associated with an object to be integrity tested to determine the presence of a leak. The apparatus comprises a pair of opposed side supports for receiving and engaging the object without blocking the leak. The side supports may be curved inwardly, and may comprise vertical members, horizontal members, or both. The side supports may further comprise rings, and may be removably mounted to a support frame. At least one side support may include a support ledge adapted for receiving and supporting an auxiliary structure associated with the object.

The object may include at least two opposed flaps, and a spacer may be provided for positioning between the flaps. The spacer may comprise a grid including rods removably mounted in a support frame, and may be generally triangular in cross section. A second spacer may also be provided for positioning between a second pair of flaps of the object. The first and second flaps may be spaced apart a first distance, and a second distance between an end of the first spacer and a second end of the second spacer. A spacer may also space at least one of the supports from a test chamber surface.

This disclosure also pertains to a method of integrity testing an object, comprising associating the object with a carrier, positioning the carrier in a chamber, delivering a detectable gas to the object, and detecting any detectable gas as a result of leak in the object. The step of delivering the detectable gas may comprise connecting tubing to the object, and the method may include the step of passing the tubing through an opening in the carrier.

A further aspect disclosed herein relates to a method of integrity testing an object. The method comprises positioning the carrier in a chamber, delivering a detectable gas to the object, delivering a carrier gas to the chamber, and detecting any detectable gas as a result of leak in the object.

Still a further aspect pertains to a method for integrity testing an object in a test chamber. The method comprises providing a base level of detectable gas to the test chamber, delivering detectable gas to the object, and detecting any detectable gas in the chamber above the base level.

Another aspect of the disclosure is a system for use in integrity testing an object for determining the presence of a leak using a source of gas. The system comprises a container for receiving the gas from the source, a delivery line for delivering an amount of gas from the container to the object, and a pressure sensor for sensing the pressure of the gas once delivered to the object. The sensed pressure may be used to determine whether the object received the gas. The system may include a comparator for comparing the sensed pressure to a pre-determined pressure associated with the object when no leak is present.

A method for use in integrity testing an object also forming a part of the disclosure comprises the steps of delivering a gas to the object, sensing the pressure of the gas, and comparing the sensed pressure to a pre-determined pressure associated with the object when no leak is present.

An apparatus forming another aspect of the disclosure comprises an apparatus for integrity testing. The apparatus comprises an object having a first interior compartment capable of receiving the conductive fluid for processing under sterile conditions, and a sensor for sensing the presence of a leak of the conductive fluid from the first interior compartment. The sensor comprises first and second electrodes. The first electrode associates with an opening to the first interior compartment of the object and the second electrode is arranged external to the first interior compartment for completing an electrical connection with the first electrode in the presence of the leak. The second electrode may comprise a liquid external to the object, which may comprise a vessel. A rigid container may also receive the vessel, the rigid container compressing the vessel so as to allow for the vessel to be filled with a liquid without being fully inflated.

A related method comprises integrity testing an inflatable object by introducing a fluid into the object while constraining the ability of the vessel to inflate, and then performing an integrity test on the object. The fluid may comprise a detectable gas, and the performing step comprises the step of detecting the detectable gas external to the object. The method may performing step may comprise providing a first electrode in communication with a liquid in the interior of the object and a second electrode external to the object, and determining whether a circuit is created between the electrodes by a leak.

A further method of integrity testing an object comprises submerging the object including a first liquid in a second liquid spaced from the first liquid by the object, and detecting the presence of a leak by determining whether a circuit is completed between the first and second liquids. The method may comprise providing the object with the first liquid while constraining the inflation of the object. The submerging step may be performed after the object is used for processing a fluid or while the object processes a fluid.

A system for use in integrity testing an article is also disclosed. The system comprises a container for containing a volume of gas from the source and a delivery line including a valve that, when open, immediately delivers the volume of gas from the container to the article. A pressure sensor may also be provided for sensing the pressure of the gas once delivered to the article.

A method of performing an integrity test on an object having an interior compartment comprises delivering a detectable gas to the interior compartment and, within a pre-determined time limit, evaluating whether the detectable gas is detectable external to the interior compartment. The method may further include the step of placing the object in a vacuum chamber prior to the delivering step, as well as the step of creating a vacuum in the vacuum chamber prior to the delivering step. The predetermined time limit may be up to about 120 seconds, or more specifically may be selected from the group consisting of 5, 10, 20, and 30 seconds. The delivering step may comprise immediately delivering a predetermined volume of the detectable gas to the interior compartment. The delivering and the detecting step both occur within 5 seconds. Any of the methods may comprise the step of cooling the object.

The method also relates to integrity testing an object having an interior compartment, comprising cooling the object prior to performing the integrity test. The step of performing the integrity test comprises introducing a detectable gas into the interior compartment of the object, and evaluating whether the detectable gas is detectable exterior of the interior compartment. The cooling step may comprise introducing a cooled detectable gas into the interior compartment, cooling a test chamber for the object, or cooling a wall of the object.

A further method of performing an integrity test on a container comprises connecting the container to a carrier, placing the carrier in a test chamber, and connecting a source of a detectable gas to the container. The method may further comprise closing the test chamber, creating a vacuum in the test chamber, and sensing for the detectable gas in the test chamber exterior to the container. The method may further include the steps of: (1) passing a tubing connecting to the container through an opening in the carrier; and (2) after the connecting step, delivering the detectable gas to the tubing. The connecting step may be performed after the placing step.

An apparatus for integrity testing in connection with a source of detectable gas comprises a manifold including a plurality of ports, tubing for connecting at least one of the ports to the source of detectable gas, and at least one device associated with another of the ports. The device may comprise a flexible bag or a clamp.

The disclosure also relates to an apparatus for integrity testing an object including an interior compartment. The apparatus comprises a container for receiving the object, the container including a chamber capable of being pressurized, and a flexible conductive porous separator adapted for substantially surrounding the object and for positioning in the container to separate a surface of the object from a surface of the container. A pump is provided for connecting to the container, and a sensor is provided for sensing a leak from the object. The apparatus may further include a delivery line for delivering a detectable gas to the interior compartment of the object, and wherein the sensor is adapted for sensing the detectable gas.

The container may comprise a rigid tank, and include at least one port for connecting to the pump. The port may be provided in a bottom wall or a sidewall of the container, and further including at least one cover for sealing the port. The container may comprise a removable lid for sealing the container to allow for pressurization. The lid may comprise a hanger for hanging the object in the container.

The object being tested may comprise a flexible bag including an impeller. The apparatus may further include a motive device for moving the impeller in the flexible bag when positioned in the chamber of the container. The separator may comprise a mesh forming a circuit with an electrode connected to a liquid in the interior compartment in the presence of a leak.

An apparatus for integrity testing an object including an interior compartment is also disclosed. The apparatus comprises a container for receiving the object, the container including a chamber capable of being pressurized. A tubular separator is provided for positioning in the container to separate a surface of the object from a surface of the container. A sensor is also provided for sensing a leak from the object.

A pump may form part of the apparatus, which pump is for connecting to the container. The tubular separator may comprise a conduit or coil adapted for passing a fluid within the container. The object may comprise a flexible bag including an impeller, and the apparatus may further include a motive device for moving the impeller in the flexible bag when positioned in the chamber of the container. A port may be provided in the container, along with at least one cover for covering the port. The cover may be elongated for receiving a tube attached to the object.

Still a further aspect of the disclosure is an apparatus for integrity testing an object, comprising a tank including a chamber with a heat exchanger and connected to a pump for pressurizing the chamber. The apparatus includes a tank connected to a motive device for moving an agitator for agitating a fluid located in a container positioned in a chamber of the tank, and a pump for evacuating the chamber. A separator in the chamber may at least partially separate the container from the tank, which separator may comprise a tube, a coiled tube, a porous material, a cloth, a fleece, a grid, a latticework, or any combination of the foregoing.

A method of performing a fluid processing operation, comprises, in a container, integrity testing an object including an interior compartment capable of receiving a fluid by delivering a detectable gas to the interior compartment. The method further includes the step of using the object in the container in the fluid processing operation. The object may comprise a flexible bag, and the integrity testing step comprise evacuating the container and detecting whether the detectable gas delivered to the object is detectable external to the object. The using step may comprise moving an agitator in the interior compartment of the object. The method may further include repeating the integrity testing after the using step, and the using step may be performed prior to the integrity testing step.

A related aspect pertains to a method of performing a fluid processing operation. The method comprises, in a container, integrity testing an object including an interior compartment capable of receiving a fluid. The method further comprises, after the integrity testing, using the object while remaining at least partially in the container in the fluid processing operation. The using step may comprise introducing a liquid to the interior compartment.

### BRIEF DESCRIPTION OF THE DRAWING FIGURES

FIGS. 1 and 2 illustrate a component having an intentional defect;

FIGS. 3 and 4 illustrate a test chamber and separator;

FIGS. 5-7 illustrate further embodiments of separators;

FIG. 8 illustrates another embodiment of a test chamber;

FIGS. 9 and 9a illustrate yet another embodiment of a test chamber;

FIGS. 10-13 illustrate a dolly for use in transporting the vessel to be tested;

FIGS. 14-19 illustrate various embodiments of spacers;

FIG. 20 illustrates one embodiment of a test chamber;

FIGS. 21-26 schematically illustrate possible modes of integrity testing; and

FIGS. 27-35 illustrate the combined use of a tank for integrity testing and fluid processing.

### DETAILED DESCRIPTION

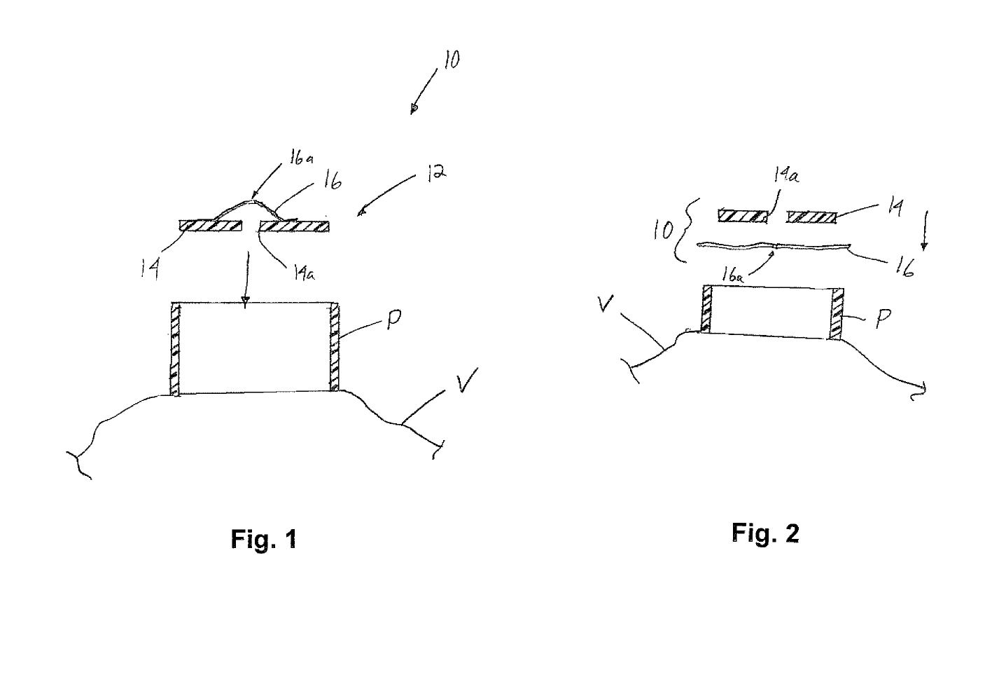

Referring now to FIGS. 1-5, one aspect of the disclosure relates to a component 10 for being removably attached to an object having an interior compartment. For example, the object may comprise a flexible vessel V, such as a bag comprising a flexible film (which may comprise one or more layers). In the illustrated form, the component 10 comprises a connector 12 adapted for being connected to an available port on the vessel V. The connector 12 may comprise a base 14 having an opening 14a for allowing the communication of gas between an interior compartment of the vessel and the environment external to the vessel. The base 14 may be adapted for connecting with the port P of the vessel V in such a manner as to create a sealing engagement between the material of the base and the port material, such that any fluid communication is solely through the opening 14a.

The base 14 may comprise a rigid metal plate including a predrilled hole to create an intentional defect. However, a rigid metal plate does not behave the same as the bag material under the testing conditions, and thus the reliability and accuracy of the results may not be assured. Hence, in other embodiments, a film 16 corresponding in properties to the film of the vessel is associated with the base 14. The film 16 may be attached directly to the base 14, such as by welding or adhesive, to form a one piece component 10 as shown in FIG. 1. The film 16 may also be secured to an external face of the base 14 as also shown in FIG. 1, or may be sandwiched between the port and the inner face of the base 14 (that is, the part of the base adjacent the interior compartment of the vessel) to form a two-piece component 10, as shown in FIG. 2.

Either the base 14 or the film 16, when present, also includes an opening (indicated by oversized marking 16a) having a pre-determined size (e.g., from about 0.01μ to about 100μ, but in the illustrated example, about 10.25μ). The opening 16a may be provided by a precision forming method, such as using a laser to drill the hole in the film 16 before or after it is associated with the base 14, or directly in the base itself when a film is not present (such as when the base is a single piece of material, such as a stainless steel cap). The opening 16a is shown as being in substantially the center of the film 16, but may be provided elsewhere if desired.

As should be appreciated, the opening 16a in the film 16 (or base 14) thus creates an “intentional defect” when associated with a vessel V, such as bag. Accordingly, as outlined further in the description that follows, a known type of flexible vessel or bag may be associated with the connector 12, such as by connecting it to a port P. The vessel V may then be integrity tested, such as by being provided with a detectable gas, and the surrounding chamber evacuated. If a detector associated with the chamber detects the detectable gas, then it is known that the opening 16a is of a size that will result in a leak when a regular bag is tested using the integrity testing apparatus.

However, if no leak is detected, then a second component (not shown) virtually identical instruction to component 10, but having an opening in the film 16 of a different size (e.g., 200, may be associated with the vessel and the test repeated. As should be appreciated, this sequence may be repeated as necessary until a leak is detected, at which time the corresponding opening size in the film would be known as that at which a leak will occur. This provides a measure of predictability and reliability for the testing regimen, since it would be known that the integrity testing would be reliable for bags having openings that might create leaks down to a known size under given test conditions. While testing using a detectable gas is one approach, the above-described apparatus may find applicability in any form of integrity testing, including pressure decay, conductivity, or the like.

As should be further appreciated, the ability to provide different components 10, such as connectors 12, having different sizes of openings avoids the need for modifying the film of the vessel itself. Accordingly, the connectors 12 may not only be used sequentially during a given test, but also potentially across multiple tests and even for different types of bags, so long as the ports are universal.

As can be appreciated, the component 10 may take different forms. For example, the component may comprise a connector of the type used as a cap in connection with a powder port, which is larger in diameter than the cap shown in FIGS. 1-2. The size of the film 16 and opening 16a may be the same as the smaller cap 12, or may vary. The component 10 may take the form of a connector, such as a tubular connector or barbed port, which may be associated with a film including the opening. The component 10 may also include a tube having a first end adapted for engaging the connector 12, and a second end adapted for connecting with a port on a container. An array of such components may be provided for sequential use.

In accordance with another aspect of the disclosure, an apparatus 20 specially adapted for testing flexible vessels known as “3D bags.” As discussed in more detail below, these bags typically have folds or gussets that disappear when the bag is inflated. Nonetheless, in the folded condition, these structures create special considerations during integrity testing.

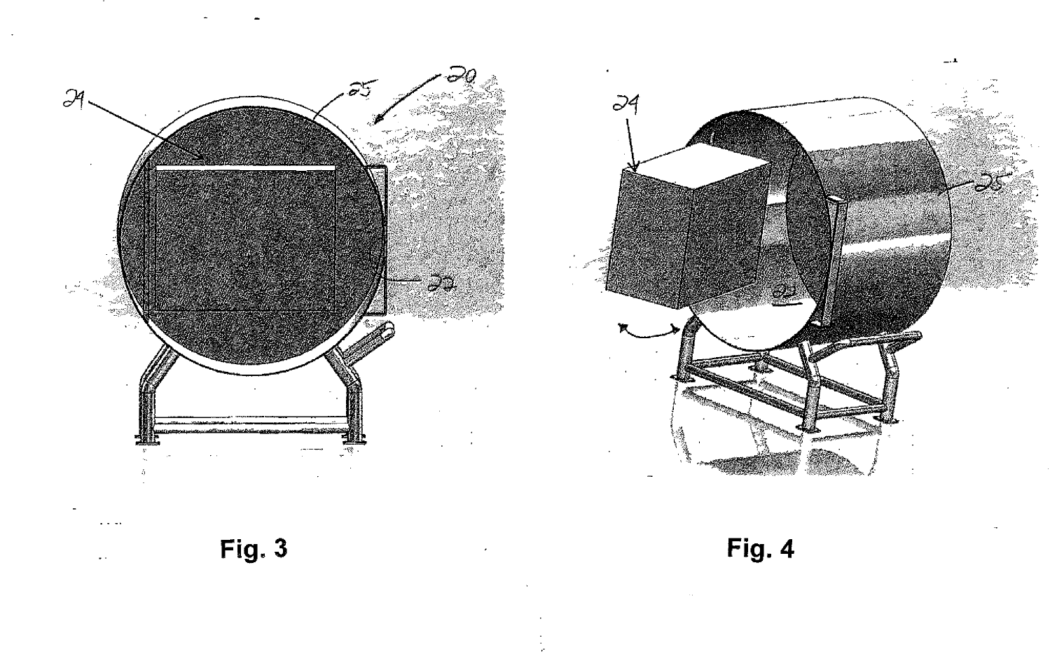

In one embodiment, as shown in FIGS. 3 and 4, the apparatus 20 comprises a chamber 22 in which a spacer 24 is provided. The spacer 24 serves to support the vessel or bag in the chamber 22 during testing. To facilitate the insertion and removal of the vessel or bag, the spacer 24 may be adapted to move to a position within the chamber 22 to a second position outside of the chamber, while remaining connected to an associated container 25. This may be achieved by swiveling through the open end of the chamber 22, which would normally be closed.

The orientation of the container 25 forming the chamber 22 is also noteworthy (basically, an open ended drum turned on its side, and thus forming a cylinder with its curved surface tangent to a horizontal plane), since it provides increased strength to withstand the hoop stress created during the evacuation process. Furthermore, it is noted that the container 25 may also include any ports for introducing the detectable gas for purposes of testing.

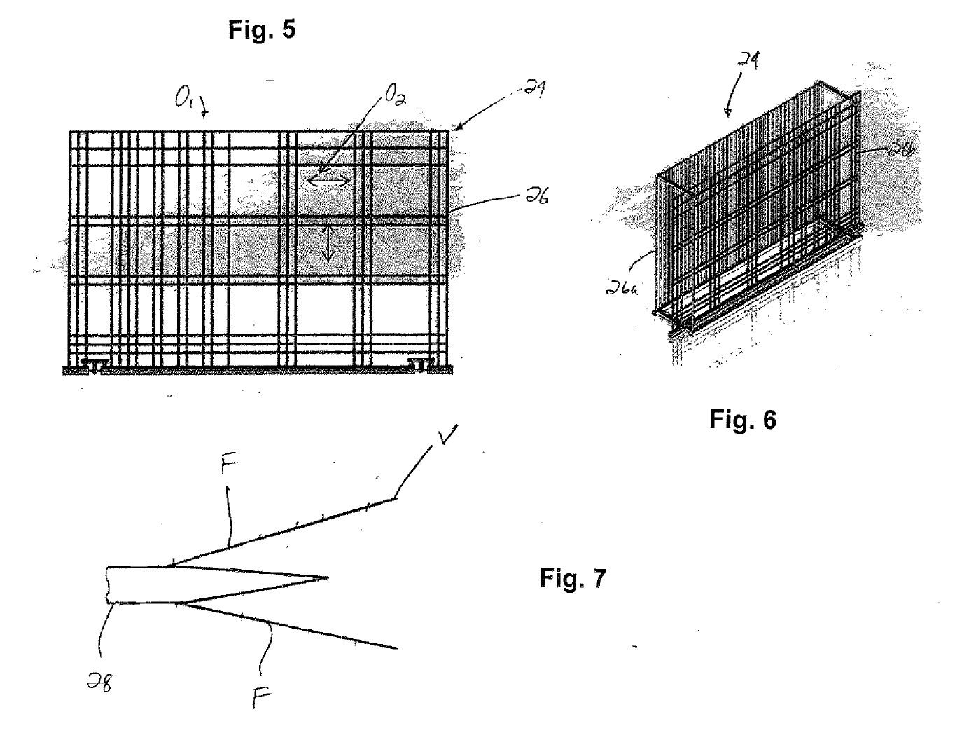

While the spacer 24 is shown schematically in FIGS. 3 and 4, it is desirable to create the spacer 24 in a manner specifically designed to accommodate bags with gussets or folds (e.g., 3-D bags) in a manner that facilitates the integrity testing. Thus, for example, the spacer 24 may comprise a grid-like or reticulated framework 26, as shown in FIGS. 5 and 6. This structure helps to prevent any leak in the vessel from being obscured by contact with an external surface, which may hinder detection.

The framework 26 may be adjustable in the width dimension to receive the vessel in an interior space between the sides 26a, 26b. For example, the framework may expand to increase the space between these sides 26a, 26b, and then may optionally be compressed. One advantage of applying compression to the vessel during the testing is that it reduces the expansion during the introduction of the detectable gas, and may help to ensure the early identification of a leak by reducing the amount of gas required. Additionally, as discussed further below, this type of arrangement for minimizing the interior volume of the vessel by preventing full inflation may be used with integrity testing involving a liquid.

It can also be understood that the openings in the framework 26 may be irregular. For example, the openings O₁ in the middle and along one end of the framework 26 may be larger than other openings O₂. This is done to accommodate any ports or other structures that may project from the vessel when positioned in the framework 26.

As shown in FIG. 7, a removable spacer 28 may also be provided for use in connection with the spacer 24. This spacer 28 is designed to be positioned between any gussets, folds or flaps F of the vessel V during testing. This helps to prevent the folds or flaps from closing in on each other and potentially blocking a leak.

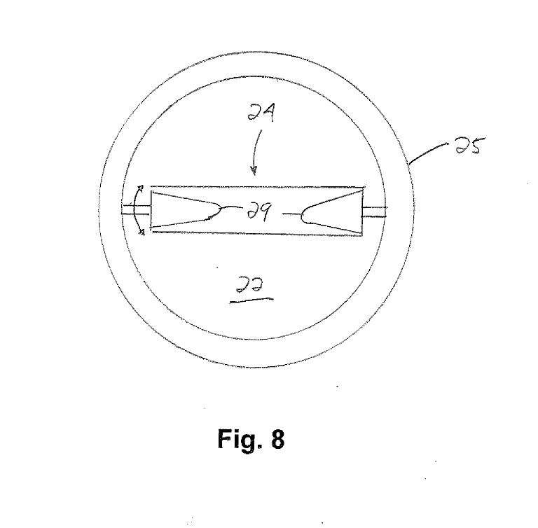

An alternative embodiment is shown schematically in FIG. 8. In this embodiment, the separator, or spacer 24, is mounted so as to be bodily rotatable within the chamber 22 formed by the container 25 (which is shown being open ended for purposes of illustration only). Accordingly, the spacer 24 may be rotated in be oriented parallel to a horizontal plane for receiving the vessel (FIG. 8), and then returned to a vertical orientation for purposes of the integrity testing in the chamber 22. The spacer 24 may also include wireframe projections 29 for positioning within any gussets or folds of the vessel to prevent collapse during the testing, as discussed previously.

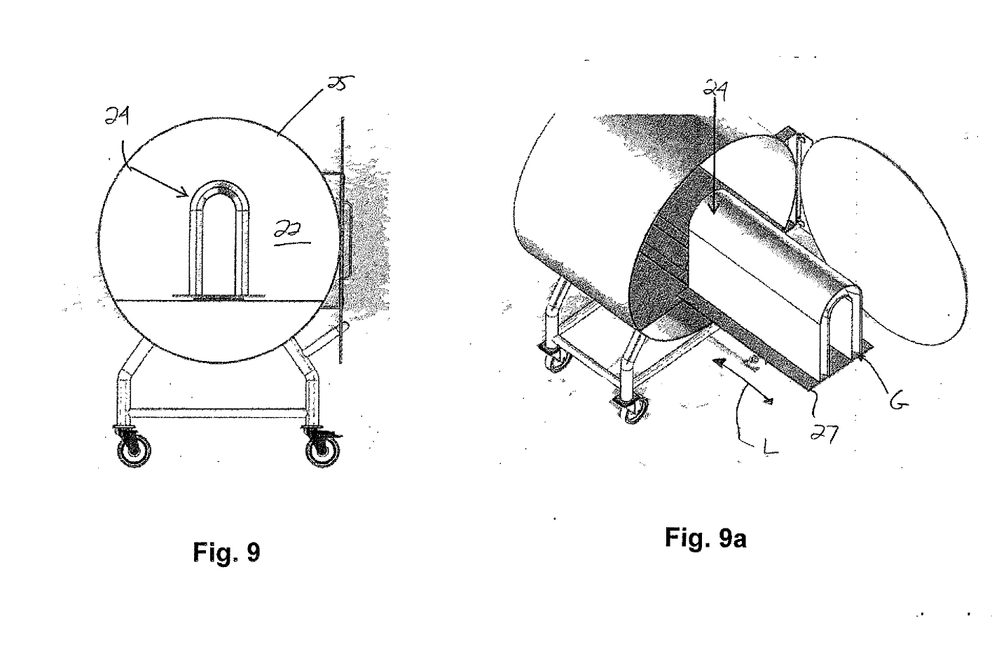

FIGS. 9 and 9a show that a separator, such as spacer 24, may also be provided such that it extends and retracts from the chamber 22 in a linear fashion (note arrow L), such as by positioning on a shuttle 27. The spacer 24 in this embodiment also includes a cross-sectional shape in the form of an inverted “U,” and is open ended to establish fluid communication with the chamber 22. The gap G between the walls of the spacer thus receives the vessel in a curved condition, which helps to reduce the size requirements of the chamber 22 without compromising the integrity testing. A removable spacer (not shown) may be provided for positioning between any flaps or folds prior to or after the insertion of the vessel into the spacer 24.

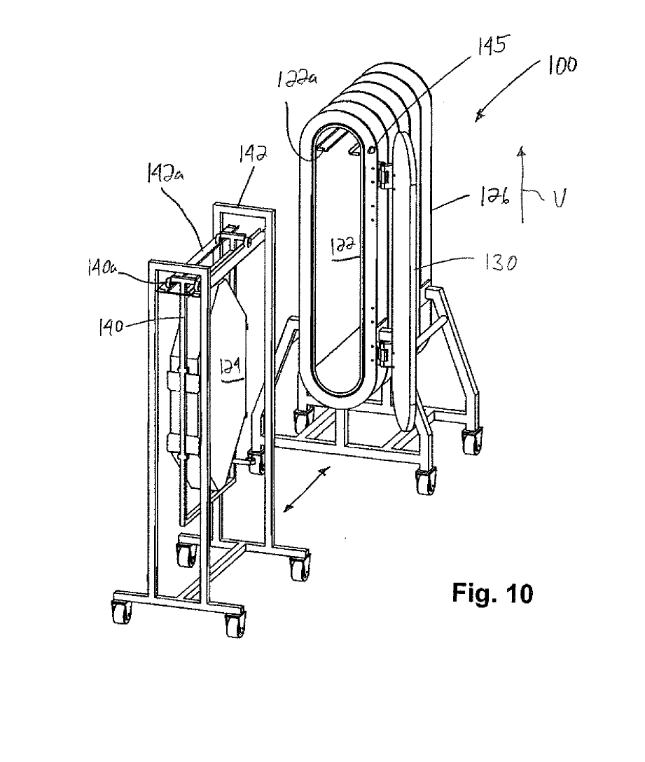

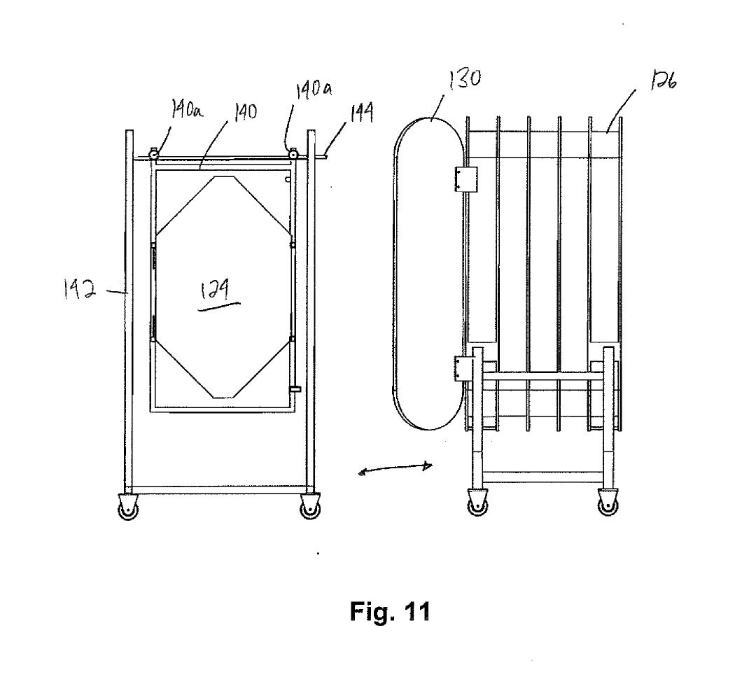

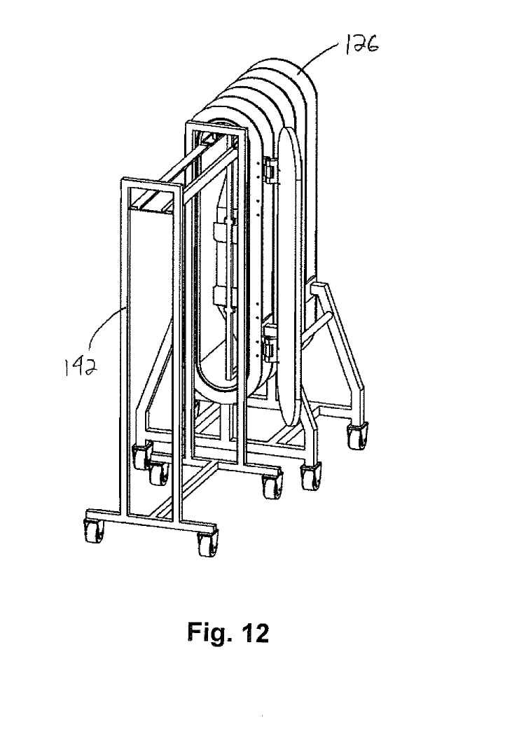

Turning now to FIGS. 10-12, a modular test system 100 is illustrated that incorporates a test chamber 122 for receiving a separator, such as spacer 124, for separating the test object from the walls of the chamber. The spacer 24 may comprise a grid-like framework forming a basket, and may move linearly into and out of the test chamber 22 formed within the container 126 (which is elongated in the vertical direction U). The container 126 may also include a suitable inlet I and outlet O for either introducing a detectable gas to the vessel, or evacuating the chamber, either of which may include a pre-attached filter for filtering any gas introduced into the chamber (either the detectable gas or a carrier gas, as discussed below). A door 130 is also provided for closing the chamber 122 when the spacer 124 is retracted. The door 130 may be formed of a transparent material to allow for the observation of the interior of the chamber 122 during the integrity testing.

Initially, the spacer 124 receives the vessel, and is connected to a shuttle 140. The shuttle 140, in turn, may be carried by a dolly 142 to a position for delivering the spacer 124 including the vessel into the chamber 122. Transfer may be achieved by rolling or sliding the shuttle 140 (note wheels 140a) along a guide 142a of the dolly 142 and onto a support, such as a guide 122a, associated with the chamber 122. The guides 142a may be height-aligned to ensure smooth delivery of the shuttle 140, and may comprise spaced rails or other structures providing a similar guide and support function for the shuttle in the pre-installed and installed conditions.

To ensure proper alignment, alignment structures, such as a locator projection 144 and corresponding aperture 145, may be provided between the dolly 142 and the structure forming the chamber 122, such as the vertically elongated container 146 shown. When the spacer 124 is positioned in the chamber 122 along with the shuttle 140, the dolly 142 may be removed. This advantageously avoids the need for carrying the spacer 124 including the vessel from a remote location for random positioning in the chamber 122 and, consequently, helps avoid the chance of perforation or other damage. Once the appropriate connections are made with the vessel, the door 130 may be closed, and the integrity testing commenced.

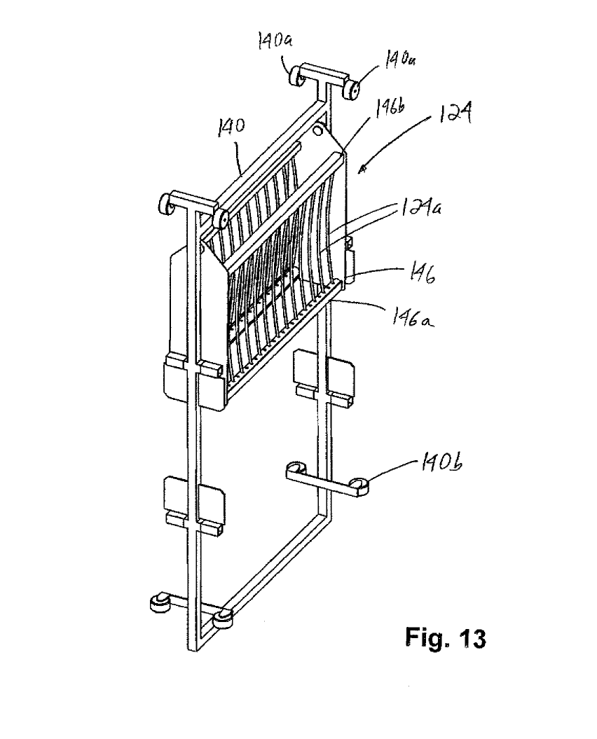

The spacer 124 serving as the separator may take various forms. For instance, as shown in FIG. 13, the spacer 124 may include a plurality of opposed support members 124a for engaging opposite lateral surfaces of the vessel when folded. The support members 124a may be curved or bowed inwardly, which helps to prevent unnecessary over expansion of the vessel during the testing regimen.

The support members 124a may also be removably connected to a support frame 146, such as by positioning in apertures in upper and lower frame members 146a, 146b. Accordingly, these modular support members 124a may be removed and replaced, as necessary to accommodate external structures on the vessel, such as port fitments, tubing, or the like. FIG. 13 also shows that the shuttle 140 may be provided with guide structures, such as bumpers or wheels 140b, for assisting in guiding the shuttle into and out of the chamber 122.

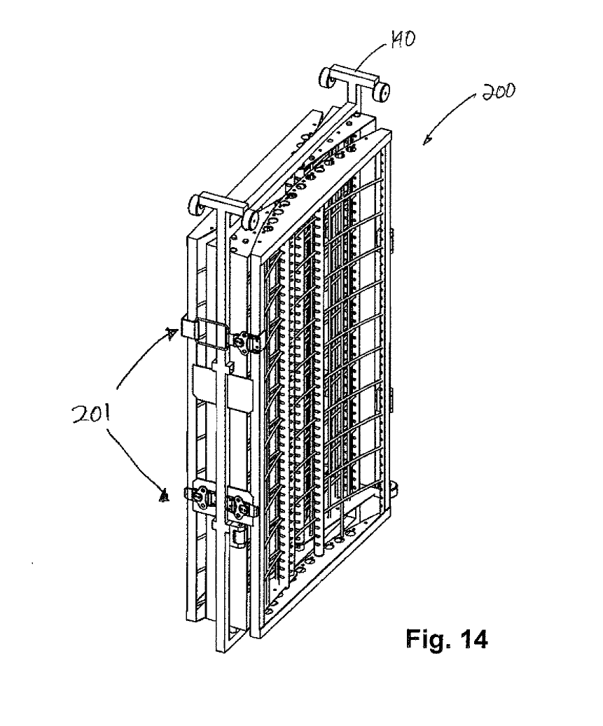

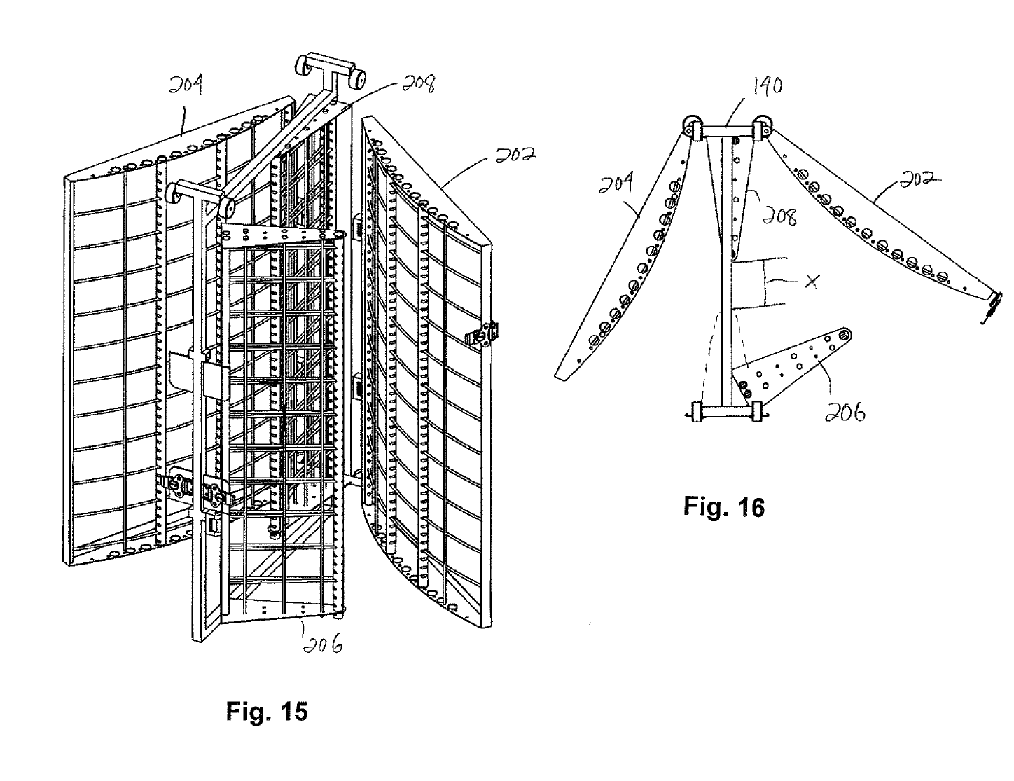

FIGS. 14-19 illustrate another embodiment of a spacer 200 serving as separator. With reference to FIGS. 15 and 16, it can be understood that the spacer 200 includes a pair of outer supports 202, 204, at least one of which is movable relative to inner supports 206, 208, such as by being connected by various hinges. In the illustrated case, both the side supports and at least one of the inner supports 206 may be pivoted outwardly relative to a base (which as indicated may comprise the shuttle 140 for positioning on a dolly (not shown) or in a corresponding container forming the test chamber) to facilitate inserting a vessel into the spacer 200. Latches 201 may be provided to retain the outer supports 202, 204 in the closed condition,

All the supports 202, 204, 206, 208 may comprise a grid or wire frame, as shown, and thus form a basket-like structure for carrying the test object, such as bag. The openings formed allow for any delivery line or other port fitments to extend into the space between the supports and the surface of the chamber.

As should be appreciated, the inner supports 206, 208 may be generally tapered from a wider outer end to a narrower, inner end, and thus designed to fit into folds at the ends of a typical 3-D bag when folded. In the illustrated embodiment, this creates a triangular profile, but other forms (e.g., trapezoidal or even semi-circular) could also be used as long as the desired spacing is provided. The outer supports 202, 208 are also bowed inwardly, which as noted above minimizes the expansion of the vessel during testing. Only one of the inner supports 206, 208 may be adapted for pivoting, and the other may be fixed in place (in which case the bag or vessel is installed on the fixed support and then the movable support can be placed between the folds).

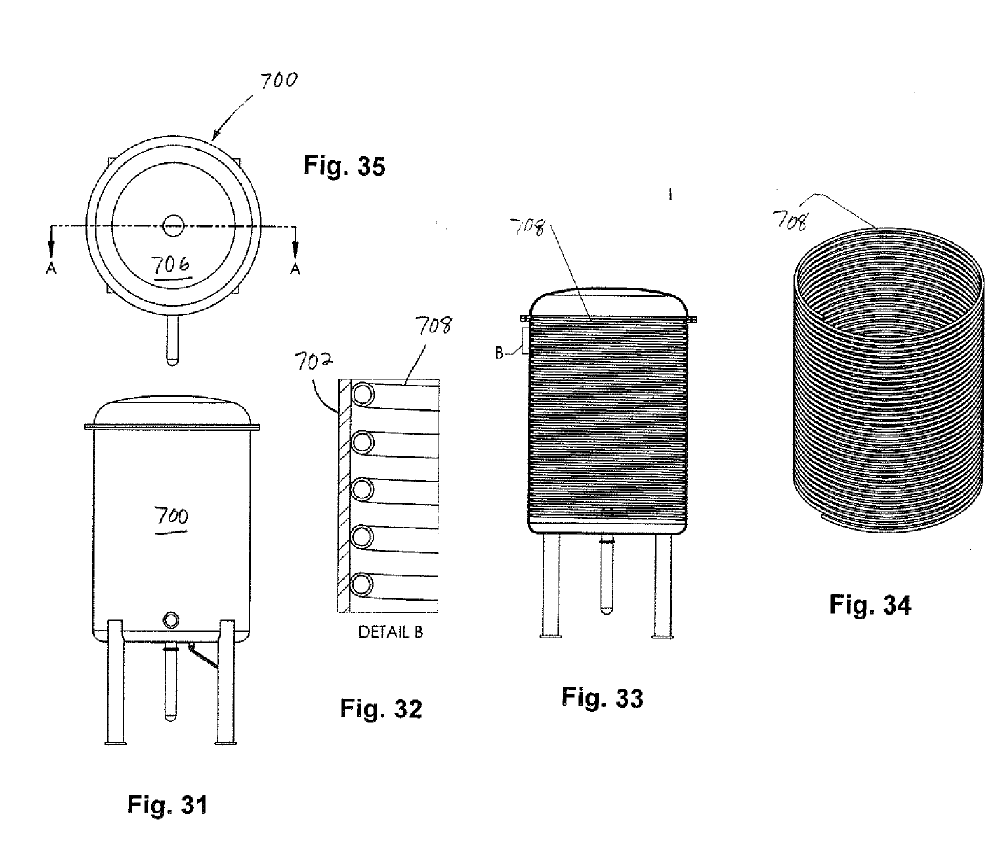

With reference to FIG. 16, it can be understood that the distance X between the ends of the inner supports 206, 208 in the home or unfolded condition may be selected to be greater than or equal to the spacing S between the ends of the folds in the vessel when folded (see FIG. 31). This spacing S is typically about 60 millimeters but may vary depending on the particular arrangement. This ensures that the vessel in the folded condition fits within the spacer 200 in the desired manner during the testing.

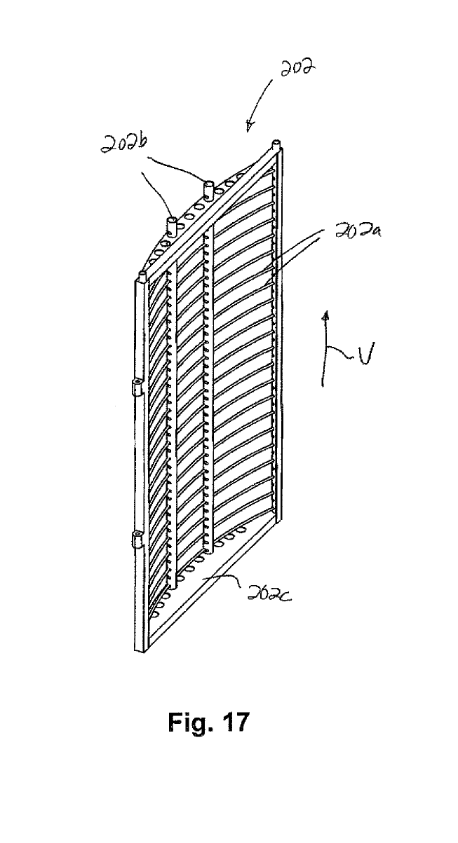

FIGS. 17-19 illustrate different manners of constructing the supports for use in the spacer 200. The outer side support 202 in FIG. 17 includes curved rails 202a positioned so as to be generally parallel to each other and a horizontal plane. The positions of these rails 202a may be adjusted in the vertical direction U as necessary to accommodate any structures associated with the vessel. Likewise, main rails 202b may be arranged to be moved laterally along the support 202, such as by positioning in apertures. An outer ledge 202c may also be provided on which any tubing or like appendages to the vessel may rest during the testing.

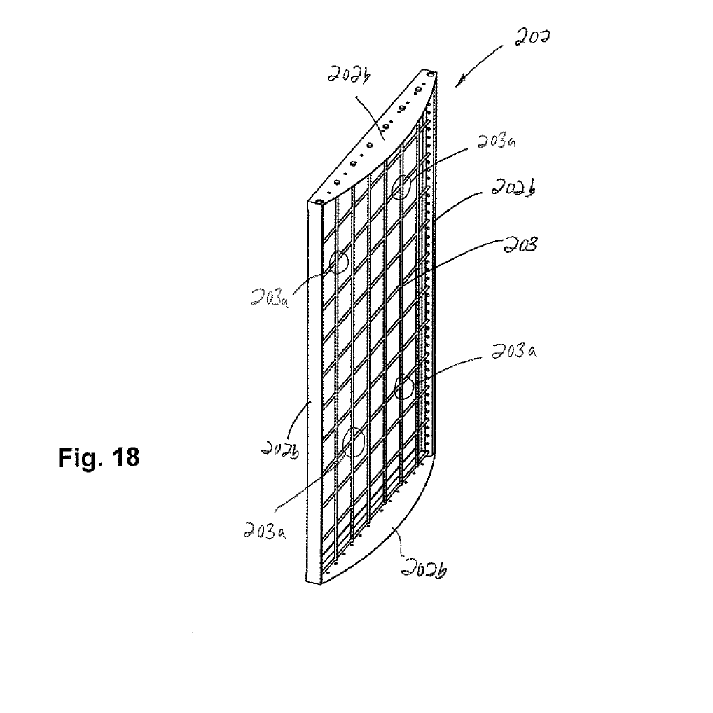

The support 202 in FIG. 18 is of a similar modular construction, but creates a grid or latticework pattern 203. The openings formed may be regular as shown, but could be irregular as well. The members forming the gridwork are substantially linear, rather than being curved, and can be adjusted as necessary along the support rails 202b forming the support 202. FIG. 18 also shows that spacers 203a, such as annular rings, posts, or other projections or like structures, may be provided along the sides of the support 202 to prevent the members of the gridwork or the associated vessel from contacting the sidewalls of the chamber during the testing procedure. Clips (not shown) may also be used to support the test object, such as the bag, within the chamber.

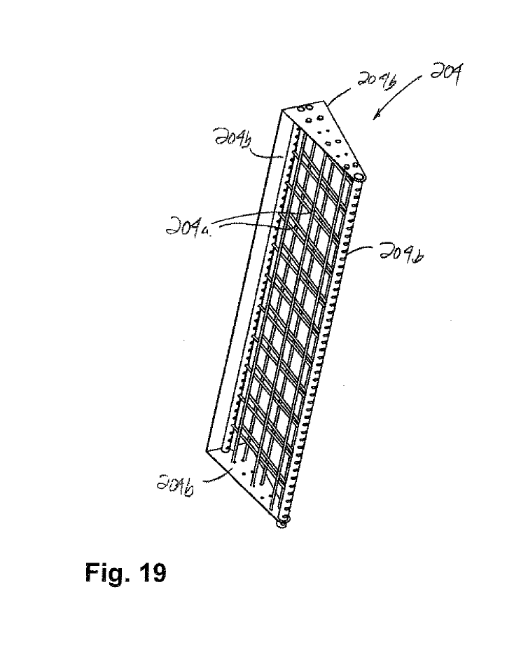

FIG. 19 shows one embodiment of an inner support 204, which comprises a grid or latticework pattern. The rails 204a of the grid may be repositioned as necessary along corresponding supports 204b (vertical and horizontal).

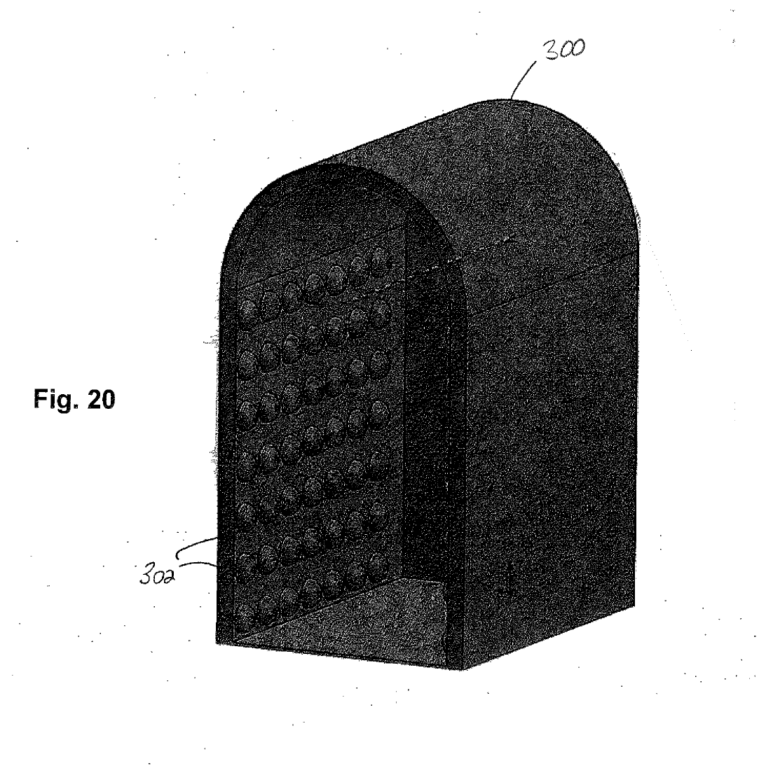

FIG. 20 illustrates that the container 300 forming the chamber for testing the vessel may be provided with a separator for separating the object to be tested from the wall. For example, a surface of the test chamber may be provided with a surface pattern. In the illustrated embodiment, this pattern takes the form of spaced hemispherical protrusions 302 arranged in rows along at least one, and two opposed sidewalls of the container 300. This pattern helps to prevent the vessel from contacting the sidewall in a manner that would allow any leak to be blocked and thus go undetected. As should be appreciated, this arrangement may be useful in any type of integrity testing involving a leaking fluid, including the pressure decay method.

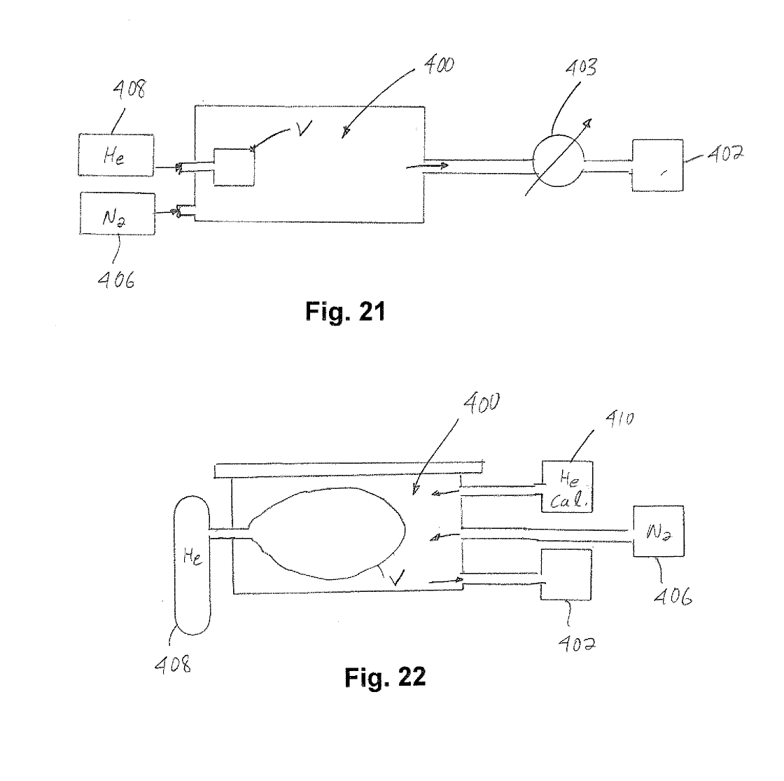

As should be appreciated, a typical leak may be very small, and thus in the case of a detectable gas may lead to a very small amount of gas being released into the test chamber. Accordingly, it may take time for the detectable gas to reach any detector. FIG. 21 illustrates further features according to the disclosure that may help expedite the testing and ensure the accuracy of the results. Specifically, a carrier gas may be introduced into the test chamber 400 at a substantially constant pressure (e.g., 1-2 torr) and withdrawn in a continuous manner and at a substantially constant pressure. The carrier gas should be different from the detectable gas (which may be Helium, as indicated) and may, for example, comprise Nitrogen or another inert gas or gas mixture that does not interfere with the detection result. This flushing of the chamber 400 with the carrier gas helps to sweep even a small number of Helium molecules resulting from any leak in the vessel V to the detector 402, which may be associated with a pump 403 for removing the gas from the chamber 400. The carrier gas may come from a source 406 adapted for delivering the gas to the chamber 400, while the detectable gas is from a separate source 408 adapted for delivering the gas to the vessel V, such as bag.

FIG. 22 illustrates that a gas corresponding to the detectable gas may be added to the chamber 400 (such as from a source 410 different from source 408, or from a common source through different valves and delivery lines). This provides a base level of detectable gas in the chamber 400 that remains steady and is higher in amount than that amount that would be caused by a leak. The base level can be monitored by detector 402. When the detectable gas is introduced into the vessel V, such as bag, and a leak occurs, this would be additive of the base level of the detectable gas, and the detector 402 may be calibrated accordingly to read or detect levels in addition to the base level, and thus indicate a leak condition. This arrangement may be used in connection with a carrier gas, such as Nitrogen, supplied at a constant pressure from a source 406 in order to facilitate detection, but this is optional.

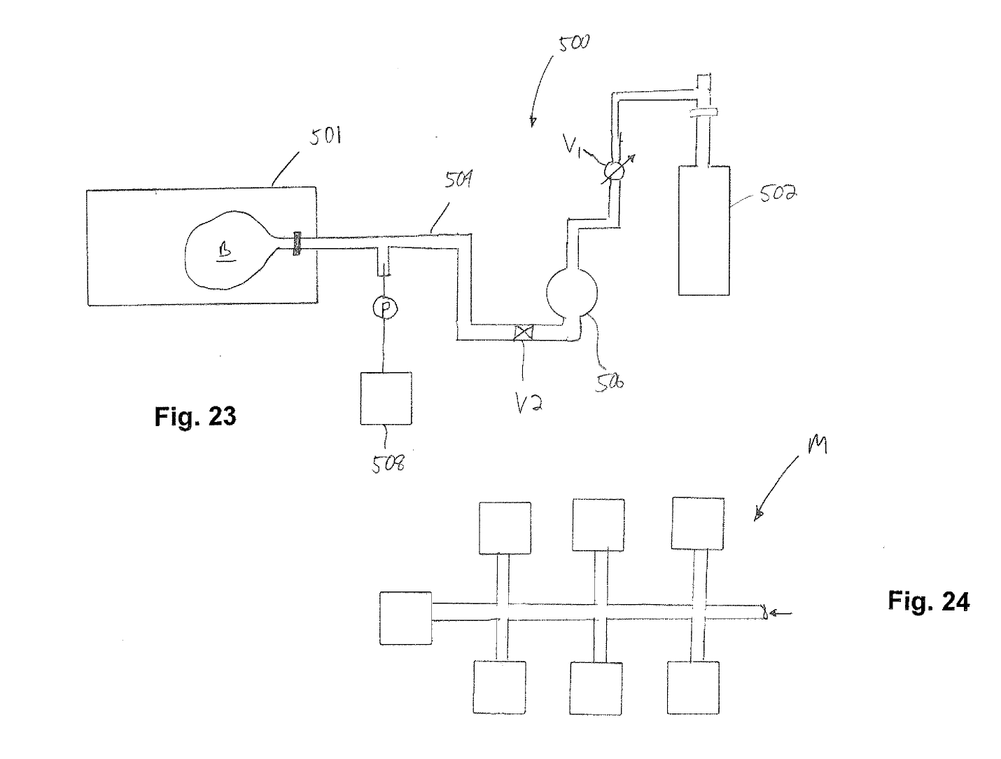

FIG. 23 shows a further aspect of the disclosure. When testing a vessel and, in particular, a container in the form of a manifold connected to a plurality of bags (see FIG. 24) using gas, a problem may be created if the gas does not fully penetrate the arrangement, as a leak may be missed (and simply introducing the gas does not assure full penetration). Hence, a proposal is made for a delivery system 500 by which a secondary “drop” volume of gas is introduced from a source (which will typically be larger) to the vessel being tested (which may be a bag B, manifold M (see FIG. 24), etc.) in a test chamber 501. The pressure is then checked to confirm that the vessel has been fully involved.

In the illustrated arrangement, a source of gas 502 (which may be the detectable gas, but need not be as any gas will work) is used to deliver a fixed volume of gas through a delivery line 504 including first valve V1 to an intermediate container 506, with a downstream valve V2 closed. Once delivery is complete, the second valve V2 is opened and a pressure sensor P is used to sense the pressure in the delivery line 504. The pressure is then checked against the pressure associated with delivering the same volume of gas to a vessel having substantially the same volume and known to be leak free, such as by using a comparator 508. If the pressures do not match, then it can be appreciated that a defect may be preventing the gas from fully penetrating into the vessel being tested, and thus leak testing cannot be reliably completed.

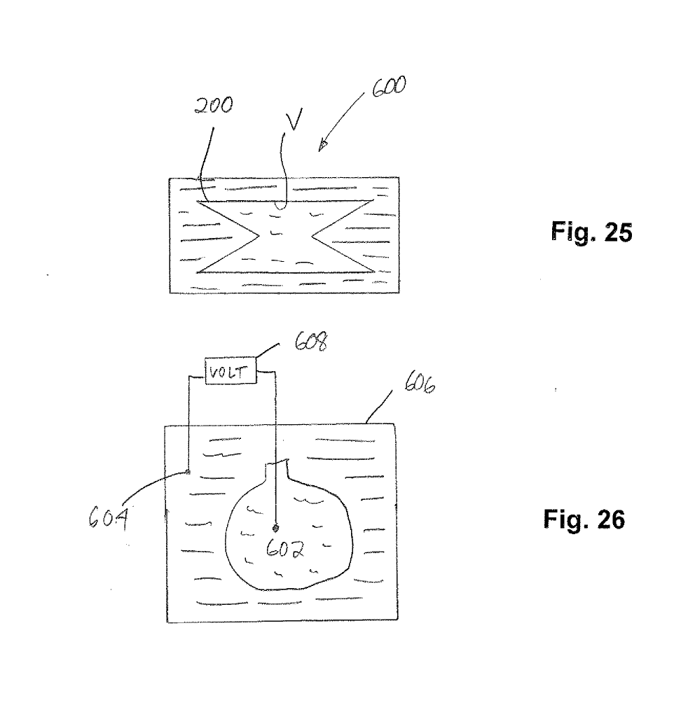

FIGS. 25 and 26 illustrate an integrity testing system 600 using a liquid, in which the vessel V (such as a bag, manifold, or the like) is not fully inflated with the liquid, but may be arranged in a device such as the spacer 200 and filled with a minimal amount of liquid (e.g., enough to coat the entire interior of the vessel, but without fully inflating it). FIG. 26 then shows that a first electrode 602 is placed in contact with the liquid in the vessel and sealed therein or thereto, and a second electrode is placed external to the vessel. In this embodiment, the second electrode 604 is formed by surrounding the vessel with a liquid in a tank 606, and the electrodes are connected to a voltage source 608. A leak in the vessel will thus complete the circuit and allow for the detection of the presence of the leak. This arrangement is particularly desirable for post-use testing, given that the vessel may already be wet from carrying the liquid and sterility is no longer a concern such that a sterile detectable gas need be used, but may also be used for in-process testing as well (that is, while the bag or vessel is being used for its intended purpose).

It may also be an important consideration to conduct the testing in an expeditious manner. Specifically, it is possible for the detectable gas, such as helium, to diffuse through the material of the container over time, such that after two minutes the detection process may be unable to distinguish between a leak and diffusion. Hence, it is desirable to take the measurement to detect the detectable gas before diffusion is likely based on the container at issue. In most cases, this will be within at least two minutes and, more preferably, within 30 seconds. For smaller (e.g., 1-5 liter bags), the time may be lowered to 10-20 seconds. The lower time is especially beneficial where the container comprises a structure comprising tubing, including a manifold, which is more susceptible to diffusion. The vacuum in the chamber should be created before the detectable gas is introduced into the bag for this reason.

In one particularly preferred embodiment, the testing is completed in a short time (e.g., about 5 seconds and less than 120 seconds) by instantaneously “dropping” a pre-determined volume of the detectable gas into the object to be tested and, with the vacuum in the chamber already created, performing the detection to see if the detectable gas is detectable (such as in the chamber or in the vacuum line). This helps to reduce the amount of time required for introducing the detectable gas, and thus further helps to reduce the false detection as a result of diffusion.

It is also possible to help prevent the diffusion issue by performing the testing under colder conditions than room temperature (such as, for example, between 32 degrees Fahrenheit and 75 degrees Fahrenheit). For instance, by dropping the temperature of one of the chamber, the container, or the detectable gas by 10 degrees Celsius or more, the potential diffusion of the detectable gas is slowed. This may help to make the testing more accurate by helping to avoid the false positives that may be created as the result of diffusion (especially when combined with the quick time to test, as noted above). While it is possible to provide the cooling in various manners, as noted above, the important consideration is the cooling of the container to be tested, since this is where the diffusion is most likely to occur.

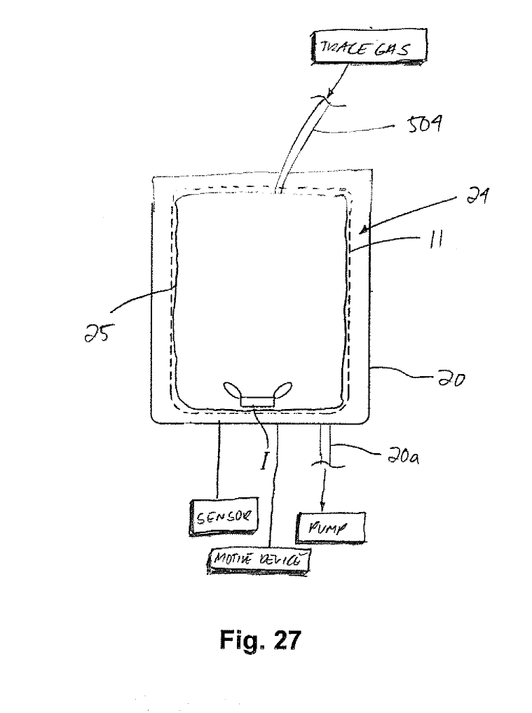

Turning to FIG. 27, it shows a separator 24 in the form of a flexible, porous material 11 for positioning in an apparatus 20 including a test chamber for receiving an object to be tested, such as a container 25 (which may optionally include an agitator, such as impeller I for being moved by a motive device external to the container). The material 11 may comprise a flexible cloth or fleece material adapted to substantially cover the object on all sides, similar to a sack, and may be separate from or a unitary part of the container 25. Thus, when the pressure differential is created via pressurization, such as by evacuation (note line 20a connected to pump) and the detectable gas is provided to the object, such as through a delivery line 504 connected to the object in the chamber, the separator 25 helps to prevent any leak from being unintentionally blocked. As indicated schematically, a sensor associated with the apparatus 20 may be used to detect whether a leak is present based on the presence (or amount) of detectable gas external to an interior compartment of the object being tested.

As can be appreciated, the apparatus 20 may be adapted for receiving the object, such as container 25, not only for purposes of testing, but also for later use. For instance, upon completion of the integrity test, the container 25 may remain in the apparatus and used for processing a fluid. This may be achieved by introducing a fluid to the container 25, which may be done through the same port used to provide the detectable gas. The fluid may be agitated, such as using the impeller I, without the container 25 being withdrawn from the test apparatus. Once the fluid is recovered, such as by draining, a post-use integrity test may be completed to ensure that no leak occurring during the fluid processing operation. As should be appreciated, the separator 24 may also remain in place during the testing but could also be removed, and need not comprise the cloth/sack embodiment, but may take any other form (such as, for example, separator in the form of spacer 124). The separator may also comprise a porous flexible conductor, which may comprise a conductive cloth or mesh (such as comprising metallized fibers) as outlined in the foregoing discussion. In such case, the liquid leak testing may be done post-processing, as contemplated herein (e.g., by completing a circuit between a liquid in the container and the mesh in the event of a leak).

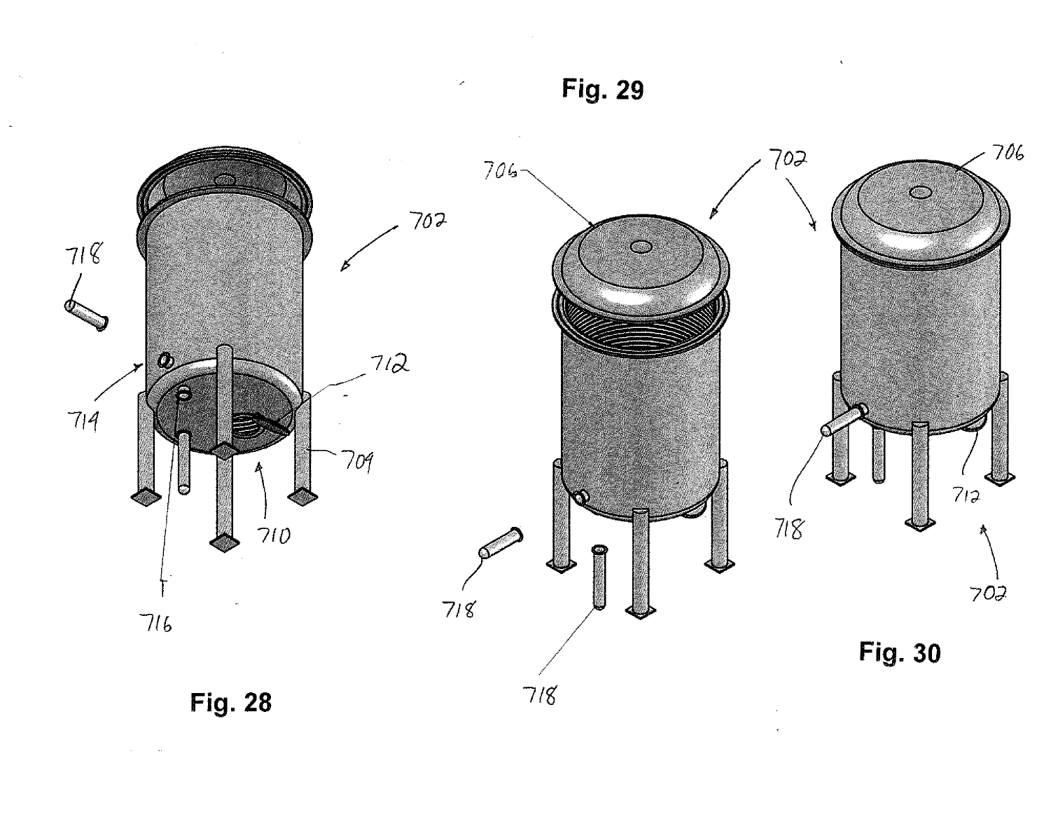

FIGS. 28-30 and 31-35 illustrate further application of the disclosed concepts. FIG. 28 shows a test apparatus 700 that may be adapted to double for use for an eventual fluid processing operation using a test object, such as a container with an interior compartment in the form of a flexible bag (not shown). The apparatus 700 may comprise a rigid container or tank 702 for receiving the object, which may include supports 704 and a removable lid 706 having a seal for hermetically sealing the interior chamber of the tank 702. The lid 706 may also be adapted for retaining the test object, such as a flexible mixing bag, in the tank 702. For example, the lid 706 may include hangers for suspending the object, such as hooks for being passed through openings formed in extensions (such as flaps) from the body of a mixing bag (which helps to support the bag during subsequent use, including inflation).

The interior chamber may include a separator taking any of the various forms disclosed herein (such as spacer 124), but in this particular example and with reference to FIG. 31, the separator comprises a heat exchanger, such as a coiled tubing 708 (as can be understood from FIG. 32 showing a cross-section of detail B in FIG. 33, which itself is a view along line A-A of FIG. 35). The object to be tested may thus be placed in the space interior of the tubing 708 in the tank 702, and the test carried out to assess whether a leak is present (in which case the tubing 708 serves to separate the object being tested from the sidewalls of the chamber). The heat exchanger formed by the tubing 708 may also be used to control the temperature of the chamber during the integrity test (such as by cooling).

During subsequent fluid processing using the apparatus 700 in the manner contemplated above, the coiled tubing 708 may be used to carry fluid to provide a heat exchange function for the operation (which may be especially desirable when the fluid processing comprises cell culturing, fermenting, or other biological processes). This may be achieved by providing fluid to the respective inlet of the tubing and exhausting it from the outlet (both of which may be connected to the tank 702). As should be appreciated, the tubing 708 may be a permanent fixture of the tank 702, and may then be reused during subsequent testing and processing of fluids.

Turning back to FIG. 28, it can also be appreciated that various ports may be provided on the apparatus for facilitate the testing and fluid processing operations performed using it. For example, a port 710 may be provided for receiving a drive structure for driving a fluid agitating element, such as an impeller, in the mixing container when positioned in the apparatus 700. The port 710 may be associated with a cover 712, which may be hingedly connected to the apparatus 700 and may include a seal (such as, for example, an O-ring), for forming a hermetic seal that allows for the pressurization (evacuation) of the chamber during the testing.

Likewise, the apparatus 700 may be provided with various ports for receiving tubing, such as along the sidewall (port 714) and bottom wall (port 716). Each port 714, 716 may be associated with a removable cover 718 for use during the test to provide a seal that allows for the desired pressurization to be achieved. In the illustrated example, the covers 718 are elongated, closed end tubes for receiving any tubing (such as for introducing or withdrawing gases or liquids) or like structures connected to the fluid processing container when placed in the apparatus. In this manner, the covers 718 may be removed once the testing is complete and accessed for introducing or withdrawing a fluid, without the need to removing the lid 706 or otherwise disturbing the fluid processing container.

The foregoing descriptions of various embodiments have been presented for purposes of illustration and description. These descriptions are not intended to be exhaustive or to limit the invention to the precise forms disclosed. For example, the object can be any object in need of integrity testing, including any vessel, tubing, or the like (as long as a sealed interior compartment can be formed for isolating the leak, such as by using clamps, caps, or like structures). The embodiments described provide the best illustration of the inventive principles and their practical applications to thereby enable one of ordinary skill in the art to utilize the invention in various embodiments and with various modifications as are suited to the particular use contemplated.

1. An apparatus for use in integrity testing a vessel using a fluid, comprising:
a container forming a test chamber for receiving the vessel; and
a spacer for separating the vessel from a surface of the test chamber, the spacer being adapted to apply compression to the vessel to reduce the expansion during the introduction of the fluid to an interior compartment of the vessel.

2. The apparatus of claim 1, wherein the spacer comprises a grid comprising a plurality of members.

3. The apparatus of claim 2, wherein one or more of the members are removable from the grid.

4. The apparatus of claim 2, wherein one or more of the members are curved toward an interior of the spacer.

5. The apparatus of claim 2, wherein the grid comprises at least one opening adapted for receiving a tubing for connecting to the container.

6. The apparatus of claim 2, wherein the grid comprises first openings having a first dimension and second openings having a second dimension.

7. The apparatus of claim 1, wherein the spacer comprises one or more structures for contacting an inner wall of the container.

8. (canceled)

9. The apparatus of claim 1, wherein the vessel is a bag comprising flaps, and the spacer is adapted for positioning between the flaps.

10. The apparatus of claim 1, further including a shuttle adapted for delivering the spacer and vessel to the test chamber.

11.-12. (canceled)

13. The apparatus of claim 1, wherein the fluid is a liquid, and wherein the container forming the detection chamber receives the spacer, the liquid, and the vessel to be tested.

14. The apparatus of claim 1, further including a first electrode for positioning in contact with a liquid in an interior compartment of the vessel, and a second electrode external to the vessel.

15.-16. (canceled)

17. The apparatus of claim 1, wherein the fluid is a detectable gas for delivery to the vessel, and further including a sensor for sensing the detectable gas in the test chamber external to the vessel.

18. The apparatus of claim 17, further including a carrier gas for carrying the detectable gas to the sensor.

19. The apparatus of claim 18, further including a base level of detectable gas external to the vessel.

20.-25. (canceled)

26. An apparatus for use in integrity testing a bag having a first interior chamber and including at least one port, comprising:
a connector adapted for connecting to the port, the connector comprising a film having an opening formed therein,
whereby the opening in the film may form an intentional defect in order to confirm the accuracy and reliability of the integrity testing.

27.-29. (canceled)

30. The apparatus of claim 26, further including a plurality of the connectors, each having an opening of a different size.

31. (canceled)

32. An apparatus for integrity testing an object with an interior compartment using a detectable gas delivered to the object, comprising:
a test chamber for receiving the vessel;
a first source of a detectable gas arranged for delivering the detectable gas to the test chamber external to the vessel.

33. The apparatus of claim 32, further including a detector for detecting the detectable gas.

34. The apparatus of claim 32, further including a source of carrier gas connected to the test chamber.

35. The apparatus of claim 32, further including a second source for delivering detectable gas to the object.

36.-48. (canceled)
